(19) United States
(12) Patent Application Publication
(10) Pub. No.: US 2006/0080518 A1
(43) Pub. Date: Apr. 13, 2006

(54) Method for securing computers from malicious code attacks

(76) Inventors: Richard Dellacona, Riverside, CA (US); Robert Arnon, Corpus Christi, TX (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/118,010

(22) Filed: Apr. 29, 2005

Related U.S. Application Data
(63) Continuation-in-part of application No. 10/962,026, filed on Oct. 8, 2004.

(51) Int. Cl. G06F 12/14

(52) U.S. Cl. 711/163

(57) ABSTRACT

A removable drive is plug compatible with a host computer preferably through its USB port. The drive auto-launches upon insertion and runs read, write and execute functions on a resident file in the removable drive, tagging the control programs of the host computer that are responsible for these functions. The control programs are then copied to the removable drive and the path for these functions is changed to the removable drive. When the removable drive is right protected, the host computer is no longer a viable target for unauthorized access.

### RELATED APPLICATIONS

This is a Continuation-in-Part application of prior filed U.S. application Ser. No. 10/962,026, filed on Oct. 8, 2004, and entitled, “Removable/Detachable Operating System.”

### BACKGROUND

1. Field of the Disclosure

This disclosure relates generally to security in computer systems and more particularly to a method of use for safeguarding a computer from malicious code attacks and other unauthorized use.

2. Description of Related Art

The following art defines the present state of this field and each U.S. disclosure is hereby incorporated herein by reference:

Adcock, U.S. Pat. No. 5,835,894, and U.S. Pat. No. 6,161,094, describe a security method that compares a present verbal utterance with a previously recorded verbal utterance by comparing frequency domain representations of the utterances, with multiple repeat utterances forming a basis for determining a variation in repetitious performance by an individual, and similar differences between enrollment and challenge utterances forming a basis for a similar analysis of variance between enrollment and challenge utterances. In one embodiment a set of enrollment data is searched by each challenge until either a match is made, indicating an action, possibly dependent upon the specific match, or no match is made indicating an abort.

Thomas et al., U.S. Pat. No. 6,016,402, describes a large capacity removable media drive that is integrated into a computer as a floppy disk drive. The method and apparatus are suited to an environment in which the removable media disk drive is configured as the first fixed disk drive in the computer. Thus, the removable media drive is recognized by the BIOS as a fixed disk drive. A substitute master boot record is provided to the computer from the removable media drive in response to a request for the master boot record of the media. Control of the boot sequence is thereby gained. The substitute master boot record loads a boot program that alters the operating system to recognize the removable media drive as a floppy disk drive.

Sallam, U.S. Pat. No. 6,421,232, describes an invention that is essentially a flat panel display, preferably for use with wearable computers, which utilizes a display which is separate from the CPU, which can perform as a static flat panel display when connected to or in communication with the computer, but can also function as a thin client PDA when independent from the computer to which it was originally connected. The device will look and function as a flat panel display and include integral activation means either through stylus, touch panel, integrated pointing device, voice, or other activation means. This activation means will be available whether the device is functioning as a display or as a thin client PDA. The device will be small enough to be worn, carried or otherwise supported by the user, but can be utilized independently as a PDA to perform data input, calendars and scheduling, memo inputting and other thin client functions, and will run a thin client operating system such as Windows.RTM. CE or Palm.RTM. OS. The enclosure itself will contain hardware sufficient to support display functions as well as a thin client motherboard. It will also contain either a wired or wireless communication bus for communicating data to the computer from which it was disconnected. Additionally, it will possess a standard or proprietary video input plug for displaying output from the underlying computer.

Clements, U.S. Pat. No. 6,519,565, describes a security method that compares a present verbal utterance with a previously recorded verbal utterance by comparing time-frequency domain representations of the utterances, with multiple repeat utterances forming a basis for determining a variation in repetitious performance by an individual, and similar differences between enrollment and challenge utterances forming a basis for a similar analysis of variance between enrollment and challenge utterances. In one embodiment a set of enrollment data is searched by each challenge until either a match is made, indicating an action, possibly dependent upon the specific match, or no match is made indicating an abort. In one application an individual is accepted or rejected as an imposter, in another application, a selected action is accepted as corresponding to a verbal command.

Cole et al., U.S. Pat. No. 6,152,372, describes a portable computer, which, when activated, a check is made to see if a user has indicated a reduced operating system is to be used. If the user has indicated the reduced operating system is to be use, the reduced operating system is activated. The reduced operating system is stored within a special memory area within the portable computer. The reduced operating system uses less system resources than a full function operating system for the portable computer. If the computer is activated and the user has not indicated the reduced operating system is to be use, the full function operating system of the portable computer is activated.

Hensley, U.S. Pat. No. 0,117,610, describes a modern computer operating system that is altered to boot and run from a protected medium such as a CD-ROM. Files and configuration information are copied from a fully configured and operational OS to a hard drive image file. File system filters and device drivers are added that implement an emulated read-write hard disk drive by servicing initial read requests from the image file, and write requests and read requests to previously written data, from a written disk sector data base. The OS is altered to load the filters and drivers during boot, and to subsequently run from the emulated read-write hard disk drive. The hard drive image file is then placed on a bootable protected medium.

Watanabe et al., U.S. Pat. No. 6,763,458, describes a computer program, and method for multiple operating system support and a fast startup capability in a computer or information appliance. It permits execution of one of a plurality of available operating systems at the time of powering on the device and where data generated within one of the plurality of operating systems is available to a different application program executing within a different operating system on the same device. Provides for unattended file transfers and appliance mode operation for playing back digital audio without the overhead associated with conventional systems. Permit various microprocessor based systems to operate efficiently and with lower overhead. In one aspect, the invention provides a device, such as a computer or information appliance, including a processor and memory coupled to the processor; a storage system coupled to the processor and storing a portion of a first operating system in a first storage region and a portion of a second operating system in a second storage region; the storage system further providing read/write compatible storage and retrieval of data for first and second application programs executing in each of the first operating system and the second operating system respectively; and a boot controller responsive to receipt of a boot control indicator when the processor initiates a boot to an operational state to control booting or the processor into a selected one of the first operating system and the second operating system. Method, computer program, and computer program product are also provided.

Rhoads et al., U.S. Pat. No. 0,158,699, describes a plurality of partitions that may be formed in a non-volatile re-programmable memory, which may act as the primary non-volatile file system for a processor-based system. The memory may store, for example, the basic input/output system for the processor-based system together with its operating system. An address partition may include information about the location of the other partitions, in association with information about the type of information stored in each partition.

Talklam, PCT 09722, describes an operating system that may be stored in a reprogrammable memory. The memory may store a primary operating system and recovery operating system. The recovery operating system may automatically obtain a new operating system to replace a corrupted or outdated operating system. In some embodiments, this avoids the need to call upon the user to load the new operating system through a disk drive and to undertake a time-consuming installation procedure.

Lambert, PCT 67132, describes a single combination data storage device that provides both firmware and disk emulation storage on a single removable media device. Permanent and programmable data of the firmware can be modified on a support computer making the combination device useful for upgrading and initially configuring the firmware for embedded systems as well as their applications, OS kernel, and user data. In a preferred embodiment, the device is implemented with a combination of flash memory for firmware and ATA/flash providing drive emulation in a PC Card or other standard form factor.

Our prior art search with abstracts described above teaches: a method for integrating a removable media disk drive into an operating system recognized as a fixed disk type and modifying an operating system to recognize it as a floppy disk type, a dual FPD and thin client, a method for allowing CD removal when booting an embedded computer operating system (OS) from a CD-ROM device, an initializing processor based system from a non-volatile reprogrammable semiconductor memory, a method of altering a computer operating system to boot and run from protected media; a system and method for installing and servicing an operating system in a computer or information appliance, organizing information stored in a non-volatile re-programmable semiconductor memory, re-loading operating systems, and a combination ATA/Linear flash memory device. Thus, the prior art shows that it is known to provide separation of CPU and memory devices as well as CPU and OS. However, the prior art fails to teach separation of the read, write and execute (RWE) instruction sets from the OS. In the present disclosure the RWE instruction sets are protected by a write control device which is manually switched between active and inactive states and may include a biometric key preventing access to unauthorized persons. The prior art fails to also describe the present disclosure in terms of its ability to physically and functionally separate the OS instruction set from CPU/memory. The prior art also fails to teach the method defined herein for protecting the OS from unauthorized use. The present invention fulfills these needs and provides further related advantages as described in the following summary.

### SUMMARY

The present disclosure teaches certain benefits in construction and use which give rise to the objectives described below.

In a best mode embodiment, a hardware/software solution is described, that protects an operating system of a computer from being accessed and manipulated by unauthorized users. Such unauthorized users typically gain access to a computer by depositing a malicious piece of code on the computer system, such pieces of code being commonly referred to as viruses, worms, Trojan horses, etc. An unauthorized user may enter a computer system while it is connected to a network through one of the system's network ports.

In the present apparatus and method, an external drive is engaged with a selected computer, as for instance, through a USB port. The external drive provides memory space and an executable program with auto-launch capability so that when the external drive is engaged through the USB port, the executable program is launched. The program requests “read,” “write” and “execute” functions on a test file in the executable program, and flags the DLL program segments, or other files, that carry out these functions in the selected computer's operating system. It then copies the flagged DLL control segments; or other files, to the external drive memory space and changes the operating path for these functions to the external drive. In a second embodiment, when the user or owner of the selected computer is not using the computer, the external drive may be removed leaving the selected computer without the ability to execute “read,” “write” or “execute” commands since the new path is now invalid without the external drive in place.

A primary objective of the present invention is to provide an apparatus and method of use of such apparatus that yields advantages not taught by the prior art.

Another objective of the invention is to prevent unauthorized use of a computer system.

A further objective of the invention is to prevent unauthorized entry to an operating system of the computer system.

A further objective of the invention is to store those portions of the operating system that control the read, write and/or execute functions on a write protect selectable memory device.

A yet further objective of the invention is to divert the operating path for control functions to a removable external drive so that the computer cannot execute such functions without the external drive being present.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate a best mode embodiment. In such drawings:

FIG. 1 is a block diagram showing alternative interconnection schemes in the embodiments of the present disclosure; and

FIG. 2 is a logic flow diagram showing a preferred method thereof.

### DETAILED DESCRIPTION

The above described drawing figures illustrate the present disclosure in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

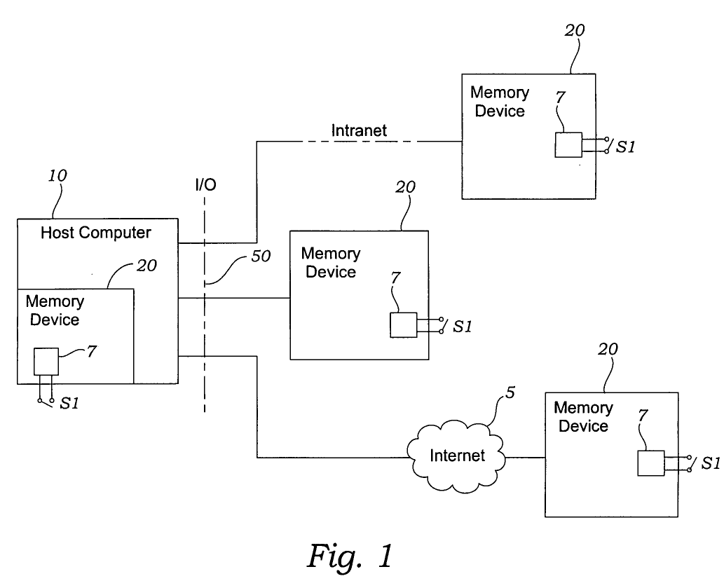

To secure a host computer 10, as shown in FIG. 1, a memory device 20, which may be a hard drive, a floppy drive, a flash card or other computer related devices such as a so-called flash-drive, for example, the JumpDrive™ made by Lexar Media, Inc., in one embodiment, is engaged through I/O port 50 with the host computer 10. I/O port 50 may be a USB port or any other known device for interconnecting the host computer with an external device as is well known. The memory device 20 may also be located remotely, and interconnected through an intranet network or through the Internet 5, as is also shown in FIG. 1. In a further alternative embodiment shown in FIG. 1, the memory device 20 may be located integrally within the host computer 10.

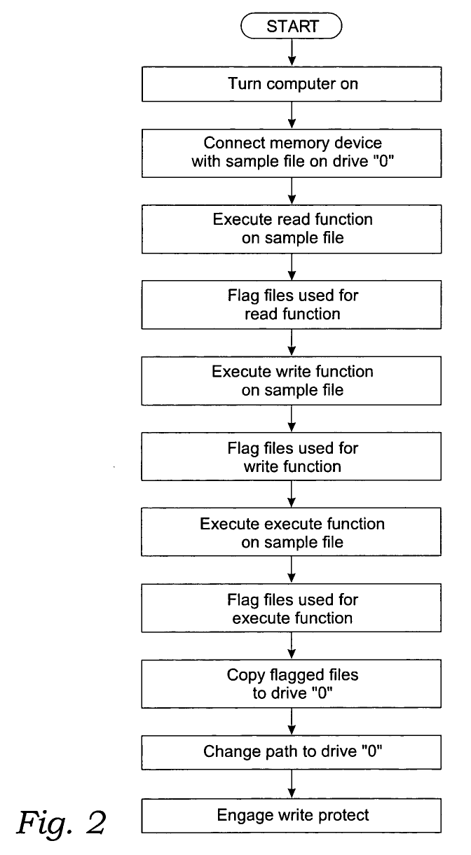

Memory device 20 provides memory space storing an executable program, preferably with auto-launch capability. The executable program is defined in the logic flow diagram of FIG. 2 and may take several forms. Auto-launch of a program held in a peripheral device is well known in the art and applied widely in the current technology, as for instance, the automatic running of an executable CD when inserted into a computer drive tray. Likewise, the executable program is preferably launched upon engagement of memory device 20. The executable program contains a file referred to as “sample file,” and this file may contain any information, as for instance, the numerals 1 to 9. Referring now to FIG. 1, when the memory device 20 is connected to the host computer, the executable program is opened and executed immediately.

The executable program performs a request of the operating system of the host computer 10 to execute the “read,” and/or “write” and/or “execute” functions on the sample file. For example, the “read” instruction is executed on the sample file. The host computer 10 immediately reads the sample file and the control program segment of the operating system in the host computer 10 is flagged so that the location of the “read” instruction set is identified. The same process is conducted for the “write” function and the “execute” function for the sample file, as shown in FIG. 1.

At this point, the control program segments (DLLs) for the three functions “read,” “write” and “execute” are now copied to the memory device 20. Next, the path for executing these three operating system segments is changed to the memory device 20 so that any command requesting any one of these functions will execute from the memory device 20 rather than from the host computer's operating system. Should the path to the memory device 20 become unavailable, as for instance if the memory device 20 is disconnected from the host computer 10, the execution of the “read,” “write” and “execute” functions automatically resort to their original addresses in the operating system.

Now, when a “write” command is requested, the revised command path is used. The memory device 20 provides a bridge chip 7 within its circuit. The bridge chip 7 provides the function of translating incoming serial data to parallel format so that it can be processed by a CPU. However, the memory device 20 also provides a physical switch S1 that is interconnected with the circuit of the memory device 20 in such a manner as to be able to disable the bridge chip, as for instance by grounding a pin or by driving the pin “high.” Clearly, other means for disabling the ability to access the “write” function in the memory device 20 would be found routinely by those of skill in the art. Reference here to the bridge chip 7 is merely for disclosing one enablement of the present apparatus and its method of execution. Alternative devices, other than the bridge chip, may be used to accomplish the same: function as described above. The use of physical switch S1 provides a fool-proof way of preventing unauthorized entry and especially of writing to the host computer 10, since a physical switch cannot be hacked.

Without an operating “read” function, the host computer 10 cannot accept a foreign read command. Without an operating “write” function, the host computer 10 is unable to write anything to any of the drives within host computer 10 or elsewhere. Without an operating “execute” function, the host computer 10 is unable to execute any foreign code. In the foregoing, the word “foreign” refers to those software commends which are undesired and unwanted and which are generally originated by unauthorized persons or computers for malicious reasons.

As previously stated, the external memory device 10 may be any external memory device, including a memory in a computer on site, off site, or remote; as long as such an external memory device has access to the host computer 10 and may be integrated and de-integrated at will with the host computer 10. Likewise, the memory device 20 may be fixtured within the host computer 10 as shown in FIG. 1.

It should be clear that the present apparatus and method of use may be applied to computers of all types including wireless devices, laptop computers, desk top computers standing alone or in a network, and also to servers and industrial computer systems.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While this disclosure has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for protecting a host computer, the method comprising the steps of: interconnecting the host computer with a memory device having a memory space containing an executable program; configuring the memory device with a physical switch having a first state enabling signal flow from the host computer to the memory device and a second state disabling signal flow from the host computer to the memory device; placing the physical switch in the first state; loading the executable program onto the host computer; executing a write function in the host computer; flagging control files of the host computer that are used in execution of the write function; copying the flagged write control files into the memory space of the memory device; executing a change-path function in the host computer to point to the copies of the control files in the memory device; and placing the physical switch into the second state for write protecting the memory device.

2. The method of claim 1 further comprising the steps of: executing a read function in the host computer; flagging control files of the host computer that are used in execution of the read function; and copying the flagged read control files into the memory space of the memory device.

3. The method of claim 2 further comprising the steps of: executing an execute function in the host computer; flagging control files of the host computer that are used in execution of the execute function; and copying the flagged execute control files into the memory space of the memory device.

4. The method of claim 1 further comprising the steps of: executing an execute function in the host computer; flagging control files of the host computer that are used in execution of the execute function; and copying the flagged execute control files into the memory space of the memory device.

5. The method of claim 1 further comprising the step of auto-launching the executable program upon interconnection of the memory device with the host computer.

6. The method of claim 1 wherein the step of interconnecting the host computer with the memory device includes interconnecting both the signal processing port and the memory device with a common intranet.

7. The method of claim 1 wherein the step of interconnecting the host computer with the memory device includes interconnecting both the signal processing port and the memory device with the Internet.

8. A method for protecting a host computer comprising the steps of: incorporating a memory device within the host computer, the memory device having a memory space containing an executable program; configuring the memory device with a physical switch having a first state enabling signal flow from the host computer to the memory device and a second state disabling signal flow from the host computer to the memory device; placing the physical switch in the first state; loading the executable program onto the host computer; executing a write function in the host computer; flagging control files of the host computer that are used in execution of the write function; copying the flagged write control files into the memory space of the memory device; executing a change-path function in the host computer to point to the copies of the control files in the memory device; and placing the physical switch into the second state for write protecting the memory device.

9. The method of claim 8 further comprising the steps of: executing a read function in the host computer; flagging control files of the host computer that are used in execution of the read function; and copying the flagged read control files into the memory space of the memory device.

10. The method of claim 9 further comprising the steps of: executing an execute function in the host computer; flagging control files of the host computer that are used in execution of the execute function; and copying the flagged execute control files into the memory space of the memory device.

11. The method of claim 8 further comprising the steps of: executing an execute function in the host computer; flagging control files of the host computer that are used in execution of the execute function; and copying the flagged execute control files into the memory space of the memory device.

12. The method of claim 8 further comprising the step of auto-launching the executable program upon startup of the host computer.

13. A method for protecting a host computer operating system for unwanted modifications, the method comprising the steps of: copying control files of the operating system to an interconnected memory device having a physical switch activated write protection mode; and directing paths for executable control functions to the memory device; and placing the physical switch into a mode for write protecting the memory device.
